(19) United States
(12) Patent Application Publication
(10) Pub. No.: US 2016/0018118 A1
(43) Pub. Date: Jan. 21, 2016

(54) Mist projector for a riding lawnmower

(71) Applicant: Sharon Lee Pirozzi, Mt. Pleasant, SC (US)

(72) Inventor: Sharon Lee Pirozzi, Mt. Pleasant, SC (US)

(21) Appl. No.: 14/821,468

(22) Filed: Aug. 7, 2015

Related U.S. Application Data
(60) Provisional application No. 62/024,975, filed on Jul. 15, 2014.

(51) Int. Cl. F24F 6/16; B01F 3/04; B01F 7/00; A01D 43/00

(52) U.S. Cl. CPC F24F 6/16; A01D 43/00; B01F 3/04042; B01F 7/00341; F24F 2006/008

(57) ABSTRACT

A plurality of vents on the dashboard area of the lawnmower direct a cooling mist on the user comprises a mist projector for a riding lawnmower. A water reservoir, contained within the lawnmower, supplies water to the vents via one or more hoses.

### CROSS-REFERENCE TO RELATED APPLICATIONS

This Application claims the benefit of U.S. Provisional Application No. 62/024,975, filed Jul. 15, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to lawn care equipment and accessories, and in particular to a mist projector for a riding lawnmower. Mowing a lawn with a riding lawnmower exposes the homeowner to severe heat and direct sunlight for extended periods. This is especially true in southern and southwestern states, and for those with exceptionally large lawns. The risk of heatstroke, dehydration, and heat exhaustion is very real. Various devices, such as umbrellas and canopies, have been developed but these do little to actually cool off the user. A mist projector for a riding lawnmower, which gently sprays a cooling mist on the user from a water reservoir contained in the lawnmower, would resolve this problem.

### SUMMARY OF THE INVENTION

Accordingly, the invention is directed to a mist projector for a riding lawnmower. A plurality of vents on the dashboard area of the lawnmower direct a cooling mist on the user. A water reservoir, contained within the lawnmower, supplies water to the vents via one or more hoses.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitutes a part of the specification. They illustrate one embodiment of the invention and, together with the description, serve to explain the principles of the invention.

FIG. 1 and FIG. 2 are front perspective views of the first exemplary embodiment installed on a lawnmower, displaying the vents 10, and the lawnmower 13.

FIG. 2 is a side transparency view of the first exemplary embodiment installed on a lawnmower, displaying a vent 10, the water reservoir 11, the hose 12, and the lawnmower 13.

FIG. 3 is a side perspective view of the first exemplary embodiment of the vents 10, displaying the switch 16 and the vent louvers 17.

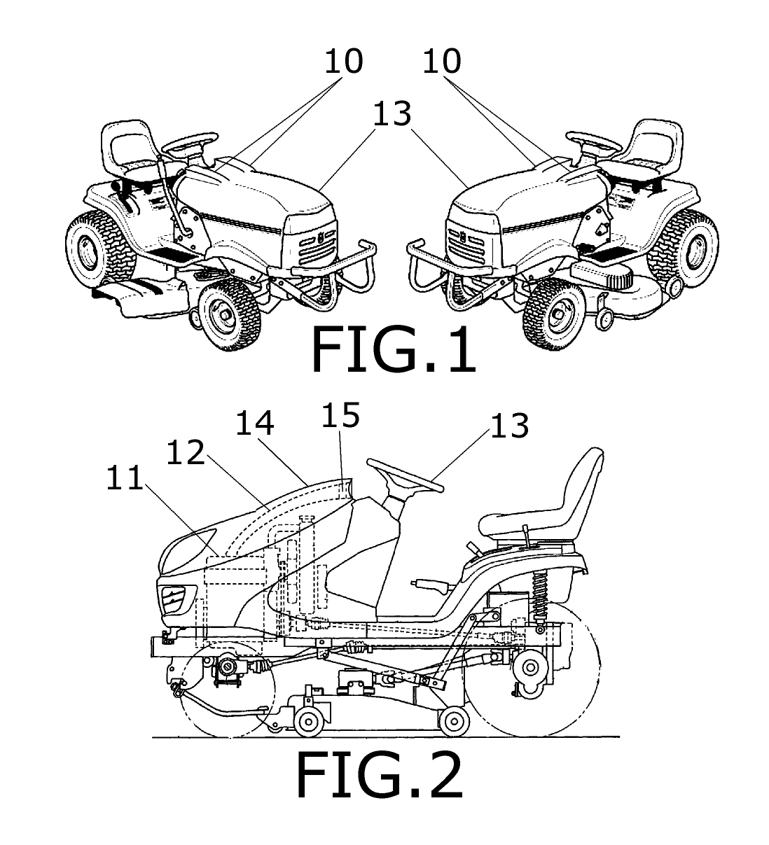

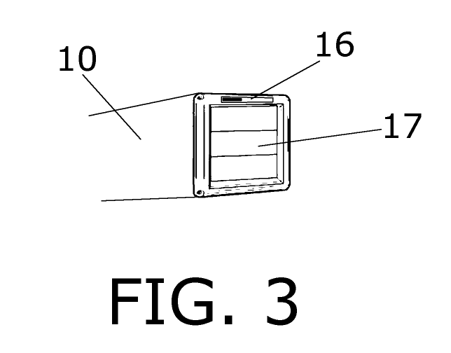

### DETAILED DESCRIPTION OF THE INVENTION

Referring now to the invention in more detail, the invention is directed to a mist projector 10 for a riding lawnmower 13.

The invention is intended for installation as original equipment by the manufacturer of the riding lawnmower. An alternate embodiment, intended for installation as an after-market modification, is contemplated.

The first exemplary embodiment is comprised of a plurality of vents 10 on the dashboard area 14 of the lawnmower 13 direct a cooling mist on the user. The vents 10 provide internal electric fans 15 to propel the mist, which are preferably powered by the electric system of the lawnmower 13, and the invention may also provide refrigeration of the water. Each vent 10 provides directional louvers 17 and an on/off switch 16 which opens the vent 10 and activates the fan 15. A water reservoir 11, contained within the lawnmower 13, supplies water to the vents 10 via one or more hoses 12.

To use the first exemplary embodiment, the user fills the reservoir 11 and may use the lawnmower 13 to mow a lawn or for other purposes. The user may activate the vents 10 as desired, using the on/off switches 16 which are provided.

The vents 10 and the reservoir 11 are preferably manufactured from rigid, durable materials, such as steel, plastic, and aluminum alloy. The hoses 12 are preferably manufactured from a flexible, durable material, such as rubber or silicone. Components and methods listed above are preferable, but artisans will recognize that alternate components and methods could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A mist projector for a riding lawnmower, comprising:
(a) a riding lawnmower;
(b) said riding lawnmower having a dashboard area;
(c) a reservoir;
(d) a hose;
(e) a vent located on said dashboard area;
(f) an electric fan;
(g) a switch;
(h) a plurality of directional louvers;
(i) said reservoir being contained within the riding lawnmower;
(j) said reservoir being connected to said vent via said hose;
(k) said electric fan being located within said vent and configured to propel fluid out of said vent; and
(l) said plurality of directional louvers being located on said vent and configured to regulate the flow of mist out of said vent, capable of being opened or closed, and capable of aiming the mist in a particular direction.

2. The mist projector for a riding lawnmower of claim 1, wherein said mist projector is a permanent installation by a manufacturer.

3. The mist projector for a riding lawnmower of claim 2, wherein said hose is a pair of hoses; said vent is a pair of vents; said electric fan is a pair of electric fans; said switch is a pair of switches.

4. The mist projector for a riding lawnmower of claim 3, wherein said reservoir is filled with water.

5. The mist projector for a riding lawnmower of claim 4, wherein said water is cooled.

6. The mist projector for a riding lawnmower of claim 3, wherein said reservoir is filled with water.

7. The mist projector for a riding lawnmower of claim 6, wherein said water is cooled.

8. The mist projector for a riding lawnmower of claim 3, wherein said switch is configured to activate said electric fan.

9. The mist projector for a riding lawnmower of claim 4, wherein said pair of switches are configured to activate their respective electric fans.

10. The mist projector for a riding lawnmower of claim 3, wherein said electric fan is powered by the electrical system of said riding lawnmower.

11. The mist projector for a riding lawnmower of claim 4, wherein said pair of electric fans are powered by the electrical system of said riding lawnmower.

12. The mist projector for a riding lawnmower of claim 1, wherein said mist projector is a modification for aftermarket installation.

13. The mist projector for a riding lawnmower of claim 12, wherein said hose is a pair of hoses; said vent is a pair of vents; said electric fan is a pair of electric fans; said switch is a pair of switches.

14. The mist projector for a riding lawnmower of claim 13, wherein said reservoir is filled with water.

15. The mist projector for a riding lawnmower of claim 14, wherein said water is cooled.

16. The mist projector for a riding lawnmower of claim 13, wherein said reservoir is filled with water.

17. The mist projector for a riding lawnmower of claim 16, wherein said water is cooled.

18. The mist projector for a riding lawnmower of claim 13, wherein said switch is configured to activate said electric fan.

19. The mist projector for a riding lawnmower of claim 14, wherein said pair of switches are configured to activate their respective fans.

20. The mist projector for a riding lawnmower of claim 12, wherein said electric fan is powered by the electrical system of said riding lawnmower.
